(19) United States
(12) Patent Application Publication
(10) Pub. No.: US 2019/0024577 A1
(43) Pub. Date: Jan. 24, 2019

(54) TURBINE HOUSING AND TURBOCHARGER

(71) Applicant: IHI Corporation, Koto-ku (JP)

(72) Inventors: Naotada UEDA, Tokyo (JP); Ryohei Kitamura, Tokyo (JP); Yukio Takahashi, Tokyo (JP)

(73) Assignee: IHI Corporation, Koto-ku (JP)

(21) Appl. No.: 16/141,306

(22) Filed: Sep. 25, 2018

Related U.S. Application Data
(63) Continuation of application No. PCT/JP2017/008452, filed on Mar. 3, 2017.

(30) Foreign Application Priority Data
May 11, 2016 (JP) 2016-095287

(51) Int. Cl. F02B 39/00; F02C 6/12; F02B 37/02; F02B 37/007; F04D 29/42

(52) U.S. Cl. CPC F02B 39/00; F02C 6/12; F05B 2220/40; F02B 37/007; F04D 29/4213; F02B 37/025

(57) ABSTRACT

A turbine housing includes: a main body portion; an insertion hole, which is formed in the main body portion, and has one end opened to an outside of the main body portion of the turbine housing and another end communicated to the turbine scroll flow passage; a pipe member, which is formed separately from the main body portion, is arranged in the insertion hole, and has a communication flow passage having an inflow port as an inlet for exhaust gas and being opened to the turbine scroll flow passage; and step surfaces (step portions), which are formed on the pipe member and the insertion hole, and are opposed to each other.

### CROSS REFERENCE TO RELATED APPLICATIONS

This application is a continuation application of International Application No. PCT/JP2017/008452, filed on Mar. 3, 2017, which claims priority to Japanese Patent Application No. 2016-095287, filed on May 11, 2016, the entire contents of which are incorporated by reference herein.

### BACKGROUND ART

### Technical Field

The present disclosure relates to a turbine housing for receiving a turbine impeller, and to a turbocharger.

### Related Art

Hitherto, there has been known a turbocharger in which a shaft is axially supported by a bearing housing so as to be rotatable. A turbine impeller is provided at one end of the shaft. A compressor impeller is provided at another end of the shaft. The turbocharger is connected to an engine. The turbine impeller is rotated by exhaust gas discharged from the engine. The rotation of the turbine impeller causes the compressor impeller to rotate through the shaft. In such a manner, the turbocharger compresses the air and sends the compressed air to the engine along with the rotation of the compressor impeller.

Among members forming the turbocharger, the turbine impeller is received in the turbine housing. A turbine scroll flow passage is formed in the turbine housing. The turbine scroll flow passage is located on a radially outer side of the turbine impeller. The turbine scroll flow passage extends in a rotation direction of the turbine impeller. For example, in Patent Literature 1, there is described a configuration in which a pipe member formed separately from a member (main body portion) forming the turbine scroll flow passage is provided. The pipe member introduces the exhaust gas into the turbine scroll flow passage. The main body portion has a through hole. The through hole penetrates from an outside of the main body portion to the turbine scroll flow passage. The pipe member is inserted into the through hole. In such a manner, a communication flow passage is formed of the pipe member. The communication flow passage continues from the outside of the main body portion to the turbine scroll flow passage.

### CITATION LIST

### Patent Literature

Patent Literature 1: Japanese Patent No. 3597752

### SUMMARY

### Technical Problem

As described above, the pipe member is inserted into an insertion hole of the main body portion of the turbine housing. With the configuration described in Patent Literature 1, when the communication passage is formed of the pipe member, there is a fear in that a position of the pipe member in an insertion direction with respect to the insertion hole is deviated. As a result, the positional deviation of the pipe member causes deviation from a predetermined turbine efficiency.

An object of the present disclosure is to provide a turbine housing and a turbocharger, which are capable of improving positioning accuracy of a pipe member with respect to a main body portion to suppress variation in turbine performance.

### Solution to Problem

In order to solve the above-mentioned problem, according to one embodiment of the present disclosure, there is provided a turbine housing, including: a main body portion; an insertion hole, which is formed in the main body portion, and has one end opened to an outside of the main body portion and another end communicated to a turbine scroll flow passage; a pipe member, which is formed separately from the main body portion, is arranged in the insertion hole, and has a communication flow passage, which has an inflow port for exhaust gas, and is opened to the turbine scroll flow passage; and step portions, which are formed on the pipe member and the insertion hole, and are opposed to each other.

The turbine housing may further include: a key groove, which is formed in one of an outer surface of the pipe member and an inner surface of the insertion hole, and extends from one end of the insertion hole to another end side of the insertion hole; and a projection, which is formed on another of the outer surface of the pipe member and the inner surface of the insertion hole, and is fitted to the key groove.

The turbine housing may further include: a tongue portion, which is formed in the main body portion, and is formed at a connection portion between a downstream end of the turbine scroll flow passage and the insertion hole; and an end portion, which is located on the another end side of the insertion hole in the pipe member, and projects toward the turbine scroll flow passage side with respect to the tongue portion on a side of facing the tongue portion.

The turbine housing may further include: a tongue portion, which is formed in the main body portion, and is formed at a connection portion between a downstream end of the turbine scroll flow passage and the insertion hole; and an end portion, which is located on the another end side of the insertion hole in the pipe member, and is located on one end side of the insertion hole with respect to the tongue portion on a side of facing the tongue portion.

In order to solve the above-mentioned problem, according to one embodiment of the present disclosure, there is provided a turbocharger, including the turbine housing described above.

### Effects of Disclosure

According to the present disclosure, the positioning accuracy of the pipe member with respect to the main body portion can be improved, thereby being capable of suppressing the variation in turbine performance.

### BRIEF DESCRIPTION OF DRAWINGS

FIG. 1 is a schematic sectional view of a turbocharger.

FIG. 2A is a perspective view of a turbine housing to which a pipe member is mounted.

FIG. 2B is a perspective view of the turbine housing from which the pipe member is removed.

FIG. 3A is a sectional view taken along the line III-III of FIG. 2A, and is an illustration of a state before the pipe member is mounted to a main body portion.

FIG. 3B is a sectional view taken along the line III-III of FIG. 2A, and is an illustration of a state after the pipe member is mounted to the main body portion.

FIG. 4A is a view for illustrating a cross section of a modification example corresponding to the cross section taken along the line of FIG. 2A, and is an illustration of a state before the pipe member is mounted to the main body portion.

FIG. 4B is a view for illustrating a cross section of a modification example corresponding to the cross section taken along the line of FIG. 2A, and is an illustration of a state after the pipe member is mounted to the main body portion.

### DESCRIPTION OF EMBODIMENT

Now, with reference to the attached drawings, an embodiment of the present disclosure is described in detail. The dimensions, materials, and other specific numerical values represented in the embodiment are merely examples used for facilitating the understanding of the present disclosure, and do not limit the present disclosure otherwise particularly noted. Elements having substantially the same functions and configurations herein and in the drawings are denoted by the same reference symbols to omit redundant description thereof. Further, illustration of elements with no direct relationship to the present disclosure is omitted.

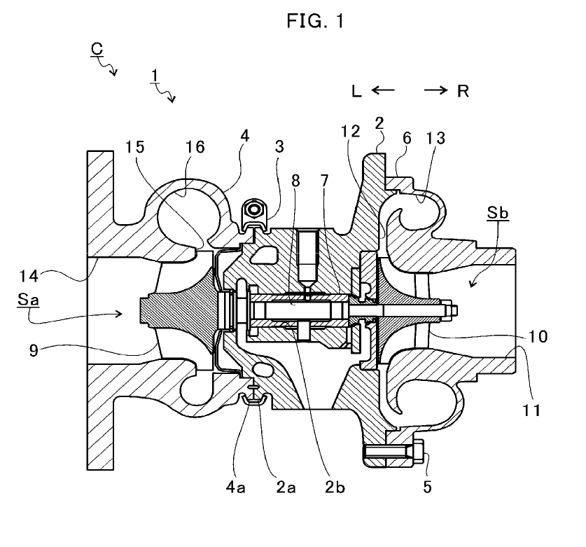

FIG. 1 is a schematic sectional view of a turbocharger C. In the following description, the direction indicated by the arrow L illustrated in FIG. 1 corresponds to a left side of the turbocharger C. The direction indicated by the arrow R illustrated in FIG. 1 corresponds to a right side of the turbocharger C. As illustrated in FIG. 1, the turbocharger C includes a turbocharger main body 1. The turbocharger main body 1 includes a bearing housing 2. A turbine housing 4 is coupled to the left side of the bearing housing 2 by a fastening mechanism 3. A compressor housing 6 is coupled to the right side of the bearing housing 2 by a fastening bolt 5. The bearing housing 2, the turbine housing 4, and the compressor housing 6 are integrated.

A projection 2a is formed in the vicinity of the turbine housing 4 on an outer peripheral surface of the bearing housing 2. The projection 2a projects in a radial direction of the bearing housing 2. A projection 4a is formed in the vicinity of the bearing housing 2 on an outer peripheral surface of the turbine housing 4. The projection 4a projects in a radial direction of the turbine housing 4. The projections 2a and 4a are fastened with a band by the fastening mechanism 3. In such a manner, the bearing housing is mounted to the turbine housing 4. The fastening mechanism 3 is formed of, for example, a G-coupling. The G-coupling nips the projections 2a and 4a.

The bearing housing 2 has a bearing hole 2b. The bearing hole 2b penetrates in the right-and-left direction of the turbocharger C. A bearing 7 is provided in the bearing hole 2b. A shaft 8 is axially supported by the bearing 7 so as to be rotatable. A turbine impeller 9 is provided at a left end portion of the shaft 8. The turbine impeller 9 is received so as to be rotatable in an impeller receiving space Sa formed in the turbine housing 4. Moreover, a compressor impeller 10 is provided at a right end portion of the shaft 8. The compressor impeller 10 is received so as to be rotatable in an impeller receiving space Sb formed in the compressor housing 6.

The compressor housing 6 has a suction port 11. The suction port 11 is opened on the right side of the turbocharger C. The suction port 11 is connected to an air cleaner (not shown). Moreover, under the state in which the bearing housing 2 and the compressor housing 6 are coupled to each other by the fastening bolt 5, a diffuser flow passage is formed. The diffuser flow passage 12 is formed of opposed surfaces of the bearing housing 2 and the compressor housing 6. The diffuser flow passage 12 increases the pressure of air. The diffuser flow passage 12 has an annular shape extending from an inner side to an outer side in a radial direction of the shaft 8. The diffuser flow passage 12 communicates to the suction port 11 through intermediation of the compressor impeller 10 on the inner side in the radial direction of the shaft 8.

Moreover, the compressor housing 6 has a compressor scroll flow passage 13. The compressor scroll flow passage 13 has an annular shape. The compressor scroll flow passage 13 is formed on the outer side with respect to the diffuser flow passage 12 in the radial direction of the shaft 8. The compressor scroll flow passage 13 communicates to a suction port of an engine (not shown). The compressor scroll flow passage 13 communicates also with the diffuser flow passage 12. Thus, when the compressor impeller 10 rotates, the air is sucked through the suction port 11 into the compressor housing 6. The sucked air is increased in speed by an action of a centrifugal force in a course of flowing through blades of the compressor impeller 10. The air having been increased in speed is increased in pressure in the diffuser flow passage 12 and the compressor scroll flow passage 13. The air having been increased in pressure is introduced to a suction port of the engine.

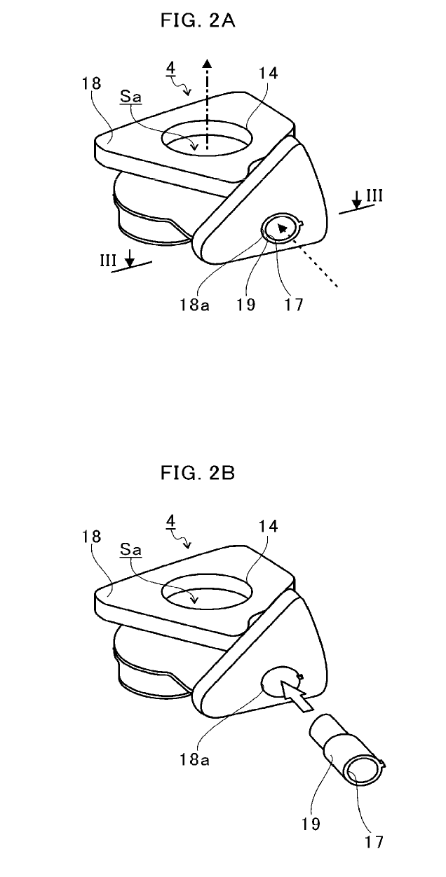

The turbine housing 4 has a discharge port 14. The discharge port 14 is opened on the left side of the turbocharger C. The discharge port 14 is connected to an exhaust gas purification device (not shown). Moreover, the turbine housing 4 has a flow passage 15 and a turbine scroll flow passage 16. The turbine scroll flow passage 16 has an annular shape. The turbine scroll flow passage 16 is formed on an outer side with respect to the flow passage 15 in a radial direction of the turbine impeller 9. Exhaust gas discharged through an exhaust gas manifold (not shown) of the engine is introduced to the inflow port 17. The turbine scroll flow passage 16 communicates to the inflow port 17 (see FIG. 2). The turbine scroll flow passage 16 communicates also with the impeller receiving space Sa through the flow passage 15. Thus, the exhaust gas having been introduced through the inflow port 17 into the turbine scroll flow passage 16 is introduced to the discharge port 14 through the flow passage 15 and the turbine impeller 9. The exhaust gas having been introduced to the discharge port 14 causes the turbine impeller 9 to rotate in the course of the flow.

A rotary force of the turbine impeller 9 is transmitted to the compressor impeller 10 through intermediation of the shaft 8. As described above, the air is increased in pressure by the rotary force of the compressor impeller 10 and then is introduced to the suction port of the engine.

FIG. 2A is a perspective view of the turbine housing 4 to which a pipe member 19 is mounted. FIG. 2B is a perspective view of the turbine housing 4 from which the pipe member 19 is removed. As indicated by the broken line arrow in FIG. 2A, the exhaust gas flows in through the inflow port 17 formed in the turbine housing 4. As indicated by the one-dot chain line arrow in FIG. 2A, the exhaust gas having passed through the impeller receiving space Sa flows out to the outside of the turbine housing 4 through the discharge port 14.

Moreover, as illustrated in FIG. 2B, the turbine housing 4 includes the pipe member 19. The pipe member 19 is formed separately from the main body portion 18 of the turbine housing 4. The pipe member 19 is a cylindrical member. The pipe member 19 has the inflow port 17 as an inlet for the exhaust gas. The pipe member 19 is inserted into an insertion hole 18a formed in the main body portion 18 in the direction indicated by the outlined arrow in FIG. 2B. The pipe member 19 is fitted to the insertion hole 18a.

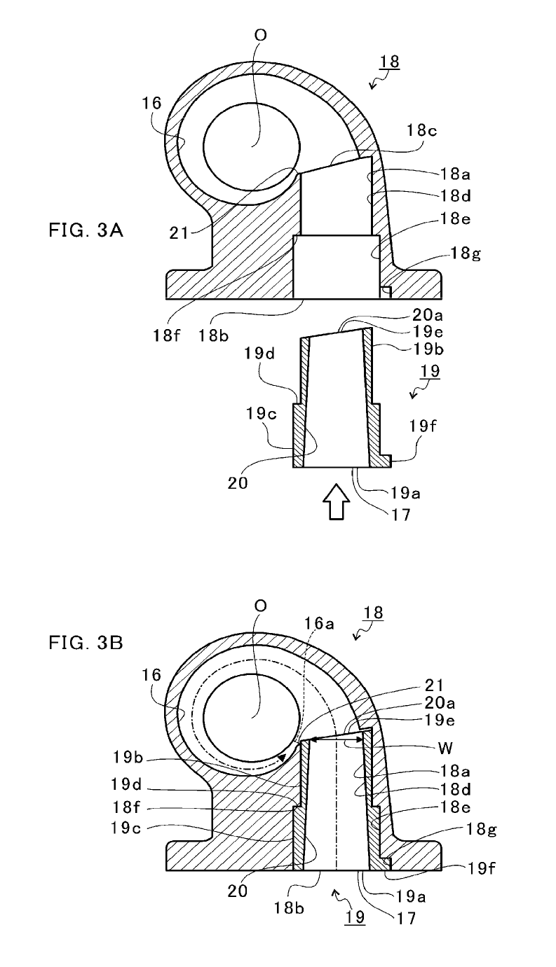

FIG. 3A is a sectional view taken along the line of FIG. 2A, and is an illustration of a state before the pipe member 19 is mounted to the main body portion 18. FIG. 3B is a sectional view taken along the line of FIG. 2A, and is an illustration of a state after the pipe member 19 is mounted to the main body portion 18.

As illustrated in FIG. 3A, the turbine scroll flow passage 16 is formed in the main body portion 18. One end 18b of the insertion hole 18a is opened to the outside of the main body portion 18. Another end 18c of the insertion hole 18a communicates to the turbine scroll flow passage 16. That is, through the insertion hole 18a, the turbine scroll flow passage 16 and the outside of the main body portion 18 communicate with each other.

As illustrated in FIG. 3B, the pipe member 19 is inserted from the one end 18b side of the insertion hole 18a. The pipe member 19 is assembled inside the insertion hole 18a. In the following description, the direction of inserting the pipe member 19 into the insertion hole 18a is simply referred to as “insertion direction”. The inflow port 17 is formed at an end portion 19a of the pipe member 19 on a lower side in FIG. 3 (rear side in the insertion direction into the insertion hole 18a).

Moreover, a communication flow passage 20 is formed in the pipe member 19. The communication flow passage 20 is a flow passage through which the inflow port 17 and the turbine scroll flow passage 16 communicate with each other. Specifically, as illustrated in FIG. 3B, the end portion 19a on the lower side in FIG. 3B in the communication flow passage 20 corresponds to the inflow port 17. An end portion 20a of the communication flow passage 20 on the upper side in FIG. 3B (front side in the insertion direction into the insertion hole 18a) is opened to the turbine scroll flow passage 16. Moreover, as an example, a flow passage width of the communication flow passage 20 is gradually reduced toward the turbine scroll flow passage 16 side. Similarly to a flow passage width of the pipe member 19 described later, a flow passage width of the turbine scroll flow passage 16 corresponds to, for example, a flow passage width in a direction perpendicular to a flow line (one-dot chain line arrow in FIG. 3B) of the exhaust gas. The flow passage width of the scroll flow passage 16 represents a flow passage sectional area which is an area of the flow passage in a cross section perpendicular to the flow line of the exhaust gas.

As indicated by the one-dot chain line arrow in FIG. 3B, the exhaust gas having flowed from the communication flow passage 20 into the turbine scroll flow passage 16 flows in an orbiting manner along a flow passage shape in the turbine scroll flow passage 16 to a tongue portion described later. The exhaust gas flows toward the radially inner side. Moreover, while the exhaust gas flows in the orbiting manner in the turbine scroll flow passage 16, part of the exhaust gas flows through the flow passage 15. The exhaust gas having flowed through the flow passage 15 flows out to the turbine impeller 9 side. A downstream end 16a of the turbine scroll flow passage 16 is connected to an upstream side in the turbine scroll flow passage 16. As an example, the flow passage width of the turbine scroll flow passage 16 is gradually reduced from the upstream side to the tongue portion on the downstream side. In the main body portion 18, a tongue portion 21 is formed at a connection portion between the downstream end 16a of the turbine scroll flow passage 16 and the insertion hole 18a. For example, the downstream end 16a is formed so as to have a minimum flow passage width at the tongue portion 21.

Incidentally, an end portion 19e of the pipe member 19 on the upper side in FIG. 3A and FIG. 3B (front side in the insertion direction) has an inclined surface. The end portion 19e is inclined with respect to a plane perpendicular to the insertion direction. The end portion 19e extends longer in the insertion direction on a side far from the tongue portion 21 (right side in FIG. 3A and FIG. 3B) than on a side of facing the tongue portion 21 (left side in FIG. 3A and FIG. 3B).

Typically, a flow passage width at the end portion 19e (indicated by the arrows W in FIG. 3B) of the pipe member 19 corresponding to a position of the tongue portion 21 is a factor influencing the turbine performance. The flow passage width of the end portion 19e is set in accordance with a predetermined turbine performance. Therefore, when the pipe member 19 is inserted into the insertion hole 18a too deep or too shallow with respect to a predetermined position in the insertion direction, the turbine performance deviates from an expected turbine performance. Such deviation in turbine performance has an influence on, for example, fuel consumption of the engine to which the turbocharger C is mounted. Therefore, there has been a demand for reducing variation in turbine performance. The flow passage width corresponds to, for example, a flow passage width in a direction perpendicular to a flow line (one-dot chain line arrow in FIG. 3B) of the exhaust gas. The flow passage width represents a flow passage sectional area which is an area of the flow passage in a cross section perpendicular to the flow line of the exhaust gas. Moreover, the flow passage may have any suitable sectional shape. For example, in a case of a sectional shape for which there is difficulty in using the flow passage width as seen in one direction to represent the flow passage sectional shape, the flow passage sectional area at the end portion 19e of the pipe member 19 corresponding to the position of the tongue portion 21 is set in accordance with a predetermined turbine performance. Moreover, when a predetermined cross section is set, it is not always required that the flow passage width (flow passage sectional area) be a width in a direction perpendicular to the flow line of the exhaust gas in a strict sense, and a deviation may be given to some extent.

Therefore, on an outer surface of the pipe member 19, there are formed a small outer diameter portion 19b and a large outer diameter portion 19c. The small outer diameter portion 19b is located on the front side in the insertion direction on the outer surface of the pipe member 19. The large outer diameter portion 19c is located on the rear side in the insertion direction with respect to the small outer diameter portion 19b. The large outer diameter portion 19c has an outer diameter larger than that of the small outer diameter portion 19b.

On the outer surface of the pipe member 19, a step surface 19d (step portion) is formed between the small outer diameter portion 19b and the large outer diameter portion 19c. The step surface 19d is formed by an outer diameter difference between the small outer diameter portion 19b and the large outer diameter portion 19c. The step surface 19d extends perpendicularly to the insertion direction. The step surface 19d is a surface which faces the front side in the insertion direction.

Meanwhile, the insertion hole 18a has a small inner diameter portion 18d and a large inner diameter portion 18e. The small inner diameter portion 18d is located on the front side in the insertion direction on an inner surface of the insertion hole 18a. The large inner diameter portion 18e is located on the rear side in the insertion direction with respect to the small inner diameter portion 18d. The large inner diameter portion 18e has an inner diameter which is larger than that of the small inner diameter portion 18d.

On the inner surface of the insertion hole 18a, a step surface 18f (step portion) is formed between the small inner diameter portion 18d and the large inner diameter portion 18e. The step surface 18f is formed by an inner diameter difference between the small inner diameter portion 18d and the large inner diameter portion 18e. The step surface 18f extends perpendicularly to the insertion direction. The step surface 18f is a surface which faces the rear side in the insertion direction. The step surface 18f and the step surface 19d are opposed to each other.

For example, the small outer diameter portion 19b and the small inner diameter portion 18d have a dimensional relationship of fitting to each other, and the large outer diameter portion 19c and the large inner diameter portion 18e have a dimensional relationship of fitting to each other. When the pipe member 19 is inserted into the insertion hole 18a, an insertion position of the pipe member 19 is determined at a position at which the step surface 18f and the step surface 19d are brought into abutment against each other. The dimensional relationship between the large outer diameter portion 19c and the large inner diameter portion 18e may be a relationship of allowing any one of loose fitting, intermediate fitting, and tight fitting. Moreover, the pipe member 19 may be press-fitted to the insertion hole 18a with a dimensional relationship between the large outer diameter portion 19c and the large inner diameter portion 18e.

Moreover, as illustrated in FIG. 3B, the end portion 19e of the pipe member 19 may be separated from any part of the main body portion 18 opposed to the end portion 19e in the insertion direction. In this case, contact between the end portion 19e and the main body portion 18 is prevented. In such a manner, the movement of the pipe member 19 toward the front side in the insertion direction can be reliably regulated through use of the step surface 18f and the step surface 19d.

The pipe member 19 is formed separately from the main body portion 18. The pipe member 19 is, for example, a member roughly having an annular shape. The pipe member 19 is easily formed by generally employed machining such as cutting. Therefore, the pipe member 19 can be enhanced in dimension accuracy as compared to a case of forming a thin-plate member by press forming such as bending or a case of another turbine housing integrally molded by casting or the like. Variation in dimension of the flow passage width at the end portion 19e corresponding to the position of the tongue portion 21 can be suppressed. Therefore, variation in turbine performance can be reduced. Moreover, in this embodiment, positioning accuracy of the pipe member 19 with respect to the insertion hole 18a in the insertion direction can be improved through use of the step surfaces 18f and 19d. As a result, the end portion 19e can be matched with the predetermined position corresponding to the tongue portion 21 with high accuracy. Therefore, the variation in turbine performance can further be reduced.

Moreover, as illustrated in FIG. 3B, the pipe member 19 is inserted into the insertion hole 18a, and is positioned through use of the step surface 18f and the step surface 19d. In this state, the end portion 19e of the pipe member 19 may project in the insertion direction with respect to the tongue portion 21 on the side of facing the tongue portion 21.

In this case, the end portion 19e of the pipe member 19 is arranged on the downstream side in the turbine scroll flow passage 16 with respect to the position of the tongue portion 21. Therefore, the degree of influence on the turbine performance by the flow passage width (flow passage area) of the end portion 19e of the pipe member 19 is enhanced. As described above, the pipe member 19 has higher dimension accuracy than that of the main body portion 18. Through use of the step surfaces 18f and 19d, the positioning accuracy of the pipe member 19 in the insertion direction with respect to the insertion hole 18a of the pipe member 19 is improved. Therefore, variation in turbine performance can be reduced. It is required that a position of the end portion 19e of the pipe member 19 be set within a range of preventing contact with the turbine impeller 9.

Moreover, as illustrated in FIG. 3A, a key groove 18g is formed in the inner surface of the insertion hole 18a. The key groove 18g extends from the one end 18b of the insertion hole 18a to the another end 18c side. A projection 19f may be formed on the outer surface of the pipe member 19. The projection 19f is fitted to the key groove 18g.

In this case, through formation of the key groove 18g and the projection 19f, the pipe member 19 can be positioned in the rotation direction. Therefore, for example, when the end portion 19e of the pipe member 19 is inclined, on the side of facing the tongue portion 21, deviation in position in the insertion direction can also be prevented.

Moreover, as illustrated in FIG. 3B, a position of the tongue portion 21 in the up-and-down direction in FIG. 3B may be located on the lower side with respect to an axial center O of the shaft 8. That is, a position of the tongue portion 21 in the insertion direction may be located on the rear side with respect to the axial center O of the shaft 8.

For example, when the tongue portion 21 is located on the upper side with respect to the axial center O of the shaft 8, it is conceivable to form the turbine scroll flow passage 16 side of the communication flow passage 20 into a shape of being curved toward an upper left side in FIG. 3B in conformity with the orbiting shape. Such a configuration is employed for the purpose of smoothly connecting the communication flow passage 20 to the turbine scroll flow passage 16. In this case, it is also required that the outer surface of the pipe member 19 and the insertion hole 18a also be curved along the communication flow passage 20. It becomes difficult to insert the pipe member 19 into the insertion hole 18a. When the tongue portion 21 is located on the lower side with respect to the axial center O of the shaft 8, the outer surface of the pipe member 19 can be set parallel to the insertion direction while preventing the curve of the outer surface as much as possible. The pipe member 19 can easily be inserted into the insertion hole 18a.

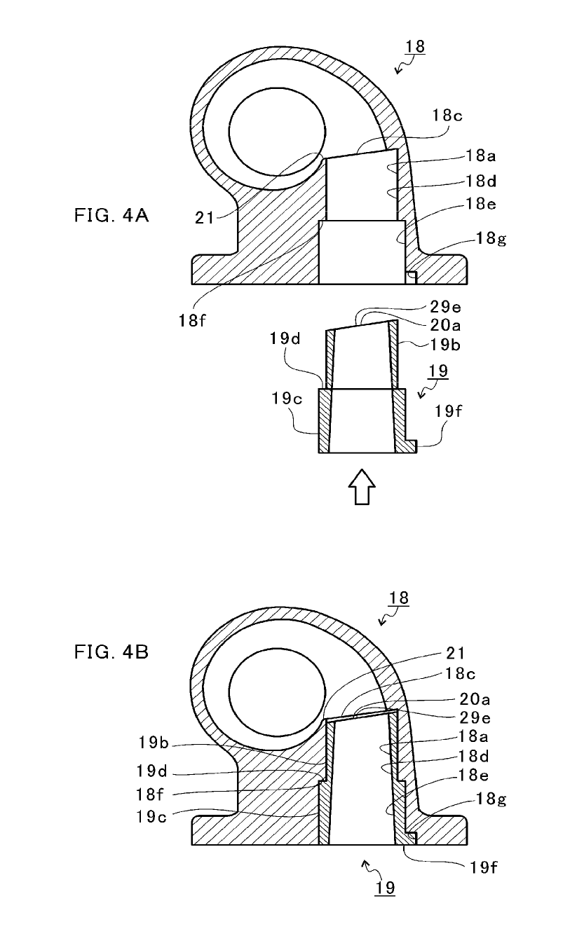

FIG. 4A is a view for illustrating a cross section of a modification example corresponding to the cross section taken along the line of FIG. 2A, and is an illustration of a state before the pipe member 19 is mounted to the main body portion 18. FIG. 4B is a view for illustrating a cross section of a modification example corresponding to the cross section taken along the line III-III of FIG. 2A, and is an illustration of a state after the pipe member 19 is mounted to the main body portion 18.

In the modification example, as illustrated in FIG. 4B, the pipe member 19 is inserted into the insertion hole 18a. Under a state in which the pipe member 19 is positioned through use of the step surface 18f and the step surface 19d, an end portion 29e of the pipe member 19 may be located on the rear side in the insertion direction with respect to the tongue portion 21 on the side in contact with the tongue portion 21.

In this case, the end portion 29e of the pipe member 19 is prevented from projecting toward the turbine scroll flow passage 16 side. There is no need to form a step on the inner wall of the turbine scroll flow passage 16. Therefore, influence of the step causing turbulence in flow of the exhaust gas in an orbiting manner to the tongue portion 21 in the turbine scroll flow passage 16 can be reduced.

The embodiment has been described above with reference to the attached drawings, but, needless to say, the present disclosure is not limited to the embodiment described above. It is apparent that those skilled in the art may arrive at various alternations and modifications within the scope of claims, and those examples are construed as naturally falling within the technical scope of the present disclosure.

For example, in the embodiment and the modification example described above, description is made of the case in which the pipe member 19 roughly has a cylindrical shape and in which the insertion hole 18a has a shape fitting to the pipe member 19 having the cylindrical shape. In this case, when the shape is roughly cylindrical, excellent processability is given, thereby being capable of improving ease of manufacturing. However, the pipe member 19 and the insertion hole 18a may have another shape.

Moreover, in the embodiment and the modification example described above, description is made of the case in which the pipe member 19 is inserted into or press-fitted to the insertion hole 18a. However, the pipe member 19 is not limited to the configuration of being inserted into or fitted to the insertion hole 18a. For example, the pipe member 19 may be mounted to the main body portion 18 by, for example, welding.

Moreover, in the embodiment and the modification example described above, description is made of the case in which the small outer diameter portion 19b and the small inner diameter portion 18d have a dimensional relationship of fitting to each other and in which the large outer diameter portion 19c and the large inner diameter portion 18e have a dimensional relationship of fitting to each other. However, the present disclosure is not limited to the configuration in which the small outer diameter portion 19b and the small inner diameter portion 18d have a dimensional relationship of fitting to each other and the configuration in which the large outer diameter portion 19c and the large inner diameter portion 18e have a dimensional relationship of fitting to each other. For example, it is only required that any one of the pairs have a dimensional relationship of fitting.

Moreover, in the embodiment and the modification example described above, description is made of the case in which the key groove 18g is formed in the inner surface of the insertion hole 18a and in which the projection 19f is formed on the outer surface of the pipe member 19. However, the key groove 18g and the projection 19f are not essentially required. Further, even when the key groove is formed in the outer surface of the pipe member 19, and the projection is formed on the inner surface of the insertion hole 18a, the pipe member 19 can be positioned in the rotation direction. Moreover, the pipe member 19 can be positioned in the rotation direction by forming a key groove in each of the inner surface of the insertion hole 18a and the outer surface of the pipe member 19, allowing the key grooves to face each other, and inserting a key being a separate member into each of both the key grooves.

Moreover, in the embodiment and the modification example described above, description is made of the turbine housing 4 of the turbocharger C as an example. However, the present disclosure is not limited to the turbocharger C, and may be applied to the turbine housing 4 for another rotary machine such as a gas turbine.

### INDUSTRIAL APPLICABILITY

The present disclosure is applicable to a turbine housing for receiving a turbine impeller, and to a turbocharger.

What is claimed is:

1. A turbine housing, comprising:
a main body portion;
an insertion hole, which is formed in the main body portion, and has one end opened to an outside of the main body portion and another end communicated to a turbine scroll flow passage;
a pipe member, which is formed separately from the main body portion, is arranged in the insertion hole, and has a communication flow passage, which has an inflow port for exhaust gas, and is opened to the turbine scroll flow passage; and
step portions, which are formed on the pipe member and the insertion hole, and are opposed to each other.

2. A turbine housing according to claim 1, further comprising:
a key groove, which is formed in one of an outer surface of the pipe member and an inner surface of the insertion hole, and extends from one end of the insertion hole to another end side of the insertion hole; and
a projection, which is formed on another of the outer surface of the pipe member and the inner surface of the insertion hole, and is fitted to the key groove.

3. A turbine housing according to claim 1, further comprising:
a tongue portion, which is formed in the main body portion, and is formed at a connection portion between a downstream end of the turbine scroll flow passage and the insertion hole; and
an end portion, which is located on the another end side of the insertion hole in the pipe member, and projects toward the turbine scroll flow passage side with respect to the tongue portion on a side of facing the tongue portion.

4. A turbine housing according to claim 2, further comprising:
a tongue portion, which is formed in the main body portion, and is formed at a connection portion between a downstream end of the turbine scroll flow passage and the insertion hole; and
an end portion, which is located on the another end side of the insertion hole in the pipe member, and projects toward the turbine scroll flow passage side with respect to the tongue portion on a side of facing the tongue portion.

5. A turbine housing according to claim 1, further comprising:
a tongue portion, which is formed in the main body portion, and is formed at a connection portion between a downstream end of the turbine scroll flow passage and the insertion hole; and
an end portion, which is located on another end side of the insertion hole in the pipe member, and is located on one end side of the insertion hole with respect to the tongue portion on a side of facing the tongue portion.

6. A turbine housing according to claim 2, further comprising:
a tongue portion, which is formed in the main body portion, and is formed at a connection portion between a downstream end of the turbine scroll flow passage and the insertion hole; and
an end portion, which is located on the another end side of the insertion hole in the pipe member, and is located on one end side of the insertion hole with respect to the tongue portion on a side of facing the tongue portion.

7. A turbocharger, comprising the turbine housing of claim 1.

8. A turbocharger, comprising the turbine housing of claim 2.

9. A turbocharger, comprising the turbine housing of claim 3.

10. A turbocharger, comprising the turbine housing of claim 4.

11. A turbocharger, comprising the turbine housing of claim 5.

12. A turbocharger, comprising the turbine housing of claim 6.
